(19) United States
(12) Patent Application Publication
(10) Pub. No.: US 2023/0136929 A1
(43) Pub. Date: May 4, 2023

(54) IDENTIFICATION METHOD, IDENTIFICATION DEVICE, AND IDENTIFICATION PROGRAM

(71) Applicant: NIPPON TELEGRAPH AND TELEPHONE CORPORATION, Tokyo (JP)

(72) Inventors: Shun TOBIYAMA, Musashino-shi, Tokyo (JP); Bo HU, Musashino-shi, Tokyo (JP); Kazunori KAMIYA, Musashino-shi, Tokyo (JP)

(73) Assignee: NIPPON TELEGRAPH AND TELEPHONE CORPORATION, Tokyo (JP)

(21) Appl. No.: 17/912,041

(22) PCT Filed: Mar. 26, 2020
(86) PCT No.: PCT/JP2020/013849

§ 371 Date: Sep. 16, 2022

(51) Int. Cl. H04L 47/2475; H04L 43/026

(52) U.S. Cl. CPC H04L 47/2475; H04L 43/026

(57) ABSTRACT

A discrimination method to be executed by a discrimination device that discriminates an application, includes collecting packet data and first flow data that satisfy a predetermined rule, analyzing the packet data and generating a signature that associates the application and an IP address with each other, generating second flow data from the packet data, calculating first feature amount information that is a statistical feature amount for each IP address for the first flow data, and calculating second feature amount information that is a statistical feature amount for each IP address for the second flow data, attaching a label to the second feature amount information with use of the signature, and causing a discriminator to learn discrimination of the application by using the first feature amount information and the second feature amount information as learning data.

### TECHNICAL FIELD

The present invention relates to a discrimination method, a discrimination device and a discrimination program.

### BACKGROUND ART

When a discriminator is generated in supervised learning for application discrimination, a large amount of data and a label corresponding to each data point are needed. Hitherto, there have been a technology of attaching a label to flow data with use of packet data and a technology of performing feature extraction with use of packet data.

### CITATION LIST

### Non-Patent Literature

Non-Patent Literature 1: T. Karagiannis, K. Papagiannaki and M. Faloutsos, “BLINC: Multilevel Traffic Classification in the Dark”, Proceedings of the ACM SIGCOMM 2005 Conference on Applications, Technologies, Architectures, and Protocols for Computer Communications, Philadelphia, Pa., USA, Aug. 22-26, 2005
Non-Patent Literature 2: Z. Chen, K. He, J. Li and Y. Geng “Seq2Img: A Sequence-to-Image based Approach Towards IP Traffic Classification using Convolutional Neural Networks”, 2017 IEEE International Conference on Big Data (Big Data).

### Summary of the Invention Technical Problem

However, when an application-level label is attached, there has been a problem in that the attachment of the label is difficult and the accuracy is low when flow data is used because the flow data only includes simple information such as an IP address and a port number. When packet data is used, the load for collection and analysis increases as the scale of the target network increases. Therefore, there has been a problem in that the attachment of an application-level label is difficult, and it is difficult to apply the technique to a large-scale network.

The present invention has been made in view of the above, and an object thereof is to provide a discrimination method, a discrimination device, and a discrimination program capable of appropriately discriminating an application that has caused traffic even in a large-scale network.

### Means for Solving the Problem

In order to solve the abovementioned problems and achieve the object, a discrimination method according to the present invention is a discrimination method to be executed by a discrimination device that discriminates an application, the discrimination method including: a collection step of collecting packet data and first flow data that satisfy a predetermined rule; a signature generation step of analyzing the packet data and generating a signature that associates the application and an IP address with each other; a flow data generation step of generating second flow data from the packet data; a calculation step of calculating first feature amount information that is a statistical feature amount for each IP address for the first flow data, and calculating second feature amount information that is a statistical feature amount for each IP address for the second flow data; an attachment step of attaching a label to the second feature amount information with use of the signature; and a learning step of causing a discriminator to learn discrimination of the application by using the first feature amount information and the second feature amount information as learning data.

A discrimination device according to the present invention is a discrimination device that discriminates an application, the discrimination device including: a collection unit that collects packet data and first flow data that satisfy a predetermined rule; a signature generation unit that analyzes the packet data and generates a signature that associates the application and an IP address with each other; a flow data generation unit that generates second flow data from the packet data; a feature amount calculation unit that calculates first feature amount information that is a statistical feature amount for each IP address for the first flow data, and calculates second feature amount information that is a statistical feature amount for each IP address for the second flow data; a label attachment unit that attaches a label to the second feature amount information with use of the signature; and a learning unit that causes a discriminator to learn discrimination of the application by using the first feature amount information and the second feature amount information as learning data.

A discrimination program according to the present invention causes a computer to execute: a collection step of collecting packet data and first flow data that satisfy a predetermined rule; a first generation step of analyzing the packet data and generating a signature that associates an application and an IP address with each other; a second generation step of generating second flow data from the packet data; a calculation step of calculating first feature amount information that is a statistical feature amount for each IP address for the first flow data, and calculating second feature amount information that is a statistical feature amount for each IP address for the second flow data; an attachment step of attaching a label to the second feature amount information with use of the signature; and a learning step of causing a discriminator to learn discrimination of the application by using the first feature amount information and the second feature amount information as learning data.

### Effects of the Invention

According to the present invention, in data retrieval including spatiotemporal data, the application that has caused traffic can be appropriately discriminated also in the large-scale network.

### BRIEF DESCRIPTION OF DRAWINGS

FIG. 1 is a block diagram illustrating one example of the configuration of a communication system in an embodiment.

FIG. 2 is a flowchart illustrating a processing procedure of learning processing according to the embodiment.

FIG. 3 is a flowchart illustrating a processing procedure of discrimination processing according to the embodiment.

FIG. 4 is a diagram describing an utilization example of a discrimination device according to the embodiment.

FIG. 5 is a diagram describing another utilization example of a discrimination device 10 according to the embodiment.

FIG. 6 is a diagram illustrating one example of a computer in which the discrimination device is realized by the execution of a program.

### DESCRIPTION OF EMBODIMENTS

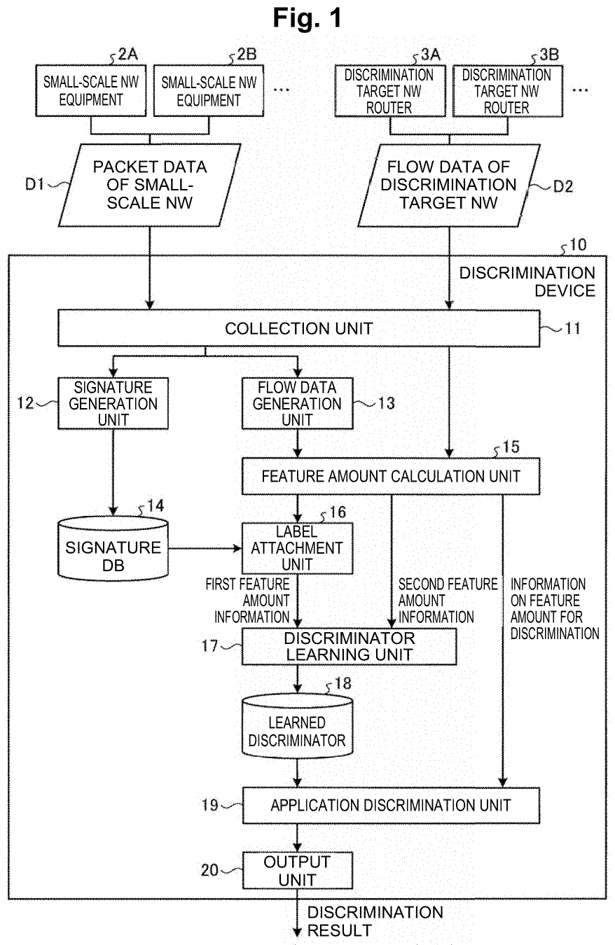

One embodiment of the present invention is described in detail below with reference to the drawings. The present invention is not limited by the embodiment. In the description of the drawings, the same reference characters are applied to the same parts.

[Embodiment] FIG. 1 is a block diagram illustrating one example of the configuration of a communication system in an embodiment. As illustrated in FIG. 1, in the communication system in the embodiment, small-scale network (NW) equipment 2A and 2B, discrimination target NW routers 3A and 3B, and a discrimination device 10 are included. The plurality of small-scale NW equipment 2A and 2B, the plurality of discrimination target NW routers 3A and 3B, and the discrimination device 10 perform communication over a network. In FIG. 1, a case where the number of the small-scale NW equipment 2A and 2B and the discrimination target NW routers 3A and 3B is plural is illustrated, but each number thereof may be single.

The small-scale NW equipment 2A and 2B transmits traffic data of a small-scale NW to the discrimination device 10 by performing mirroring of traffic and the like in the small-scale NW. The small-scale NW equipment 2A and 2B transmits packet data D1 of the small-scale NW to the discrimination device 10.

The discrimination target NW routers 3A and 3B are routers provided in a discrimination target NW of an application, and collects network flow data (flow data) D2 of the discrimination target NW with use of a flow collection function and the like in the discrimination target NW, and transmits the network flow data D2 to the discrimination device 10.

The discrimination device 10 discriminates an application (for example, a Web application) that has caused traffic from the flow data in the discrimination target NW. The discrimination device 10 uses flow data of the discrimination target NW without a label in learning with use of domain adaptation after causing a discriminator to learn the discrimination of the application in advance with learning data with a label generated from data of the small-scale NW. By the above, the discrimination device 10 constructs a discriminator capable of discriminating the application also in the flow data in a large-scale discrimination target NW.

[Discrimination Device] Next, with reference to FIG. 1, the discrimination device 10 is described. As illustrated in FIG. 1, the discrimination device 10 includes a collection unit 11, a signature generation unit 12, a flow data generation unit 13, a signature database (DB) 14, a feature amount calculation unit 15, a label attachment unit 16, a discriminator learning unit 17 (learning unit), a learned discriminator 18, an application discrimination unit 19 (discrimination unit), and an output unit 20.

The discrimination device 10 is realized when a predetermined program is read into a computer and the like including a read only memory (ROM), a random access memory (RAM), a central processing unit (CPU), and the like and the predetermined program is executed by the CPU, for example. The discrimination device 10 includes a communication interface that transmits and receives various information to and from other devices that are connected over a network and the like. For example, the discrimination device 10 includes a network interface card (NIC) and the like and performs communication with other devices over an electric telecommunication line such as a local area network (LAN) and the Internet.

The collection unit 11 collects packet data and flow data that satisfy a predetermined rule. At the time of learning, the collection unit 11 collects the packet data D1 of the small-scale NW transmitted from the small-scale NW equipment 2A and 2B and the flow data D2 (first flow data) of the discrimination target NW that is a large-scale NW transmitted from the discrimination target NW routers 3A and 3B. The packet data D1 of the small-scale NW is packet data of a small-scale NW of which scale is at a level in which a label can be attached by processing in a subsequent stage.

At the time of learning, the collection unit 11 outputs the packet data D1 of the small-scale NW to the signature generation unit 12 and the flow data generation unit 13. At the time of learning, the collection unit 11 outputs the first flow data to the feature amount calculation unit 15. At the time of discrimination, the collection unit 11 collects the flow data of the discrimination target NW serving as the discrimination target, and outputs the flow data to the feature amount calculation unit 15.

The signature generation unit 12 analyzes the packet data D1 of the small-scale NW and generates a signature that associates the application and the IP address with each other. The signature generation unit 12 analyzes the packet data collected in the small-scale NW by a DPI device and the like, and generates a signature that associates a label (for example, the name of the application) indicating an application category that has generated the packet data, and a tuple of a transmission source IP address, a transmission destination IP address, a port number, and the time at which the packet is recorded with each other.

The flow data generation unit 13 generates second flow data from the packet data D1 of the small-scale NW.

The signature DB 14 associates the label indicating the application category and the tuple of the IP address of the transmission source, the IP address of the transmission destination, the port number, and the time at which the packet is recorded that are generated by the signature generation unit 12 with each other and stores the label and the set therein.

At the time of learning, the feature amount calculation unit 15 calculates first feature amount information that is a statistical feature amount for each IP address for the first flow data that is the flow data D2 of the discrimination target NW. At the time of learning, the feature amount calculation unit 15 calculates second feature amount information that is a statistical feature amount for each IP address for the second flow data generated from the packet data D1 of the small-scale NW by the flow data generation unit 13. At the time of discrimination, the feature amount calculation unit 15 calculates information on feature amount for discrimination that is a statistical feature amount for each IP address for the flow data of the discrimination target NW that is the discrimination target.

The feature amount calculation unit 15 calculates at least one of a histogram of the packet count, a histogram of the byte count, or a histogram of the byte count and the packet count from a set of flow data of which transmission source and/or transmission destination is a certain IP address per 24 hours. Specifically, the feature amount calculation unit 15 calculates, for the first flow data, the amount of statistics such as an average of the byte count per packet for each of the transmission destination IP address and the transmission source IP address, and extracts the amount of statistics as the first feature amount information. The feature amount calculation unit 15 calculates, for the second flow data, the amount of statistics such as an average of the byte count per packet for each of the transmission destination IP address and the transmission source IP address, and extracts the amount of statistics as the second feature amount information.

At the time of learning, the label attachment unit 16 attaches a label to the second feature amount information with use of the signature generated by the signature generation unit 12.

The discriminator learning unit 17 causes the discriminator to learn the discrimination of the application by using the first feature amount information and the second feature amount information as learning data. The discriminator learning unit 17 performs prior learning of the discriminator with use of the second feature amount information with the label attached thereto generated by the label attachment unit 16. Then, the discriminator learning unit 17 performs the learning of the discriminator by a domain applying technology with use of the first feature amount information and the second feature amount information without a label. The discriminator learning unit 17 performs the learning of the discriminator by domain adaptation with use of the discriminator obtained in the prior learning, the first feature amount information, and the second feature amount information without a label.

The learned discriminator 18 is a discriminator that has become able to discriminate the application corresponding to the IP address of the flow data that is the discrimination target by the prior learning and learning in the discriminator learning unit 17. Specifically, the feature amount information of the flow data that is the discrimination target is input to the learned discriminator 18, and the learned discriminator 18 outputs the probability of the IP address of the flow data that is the discrimination target providing each application.

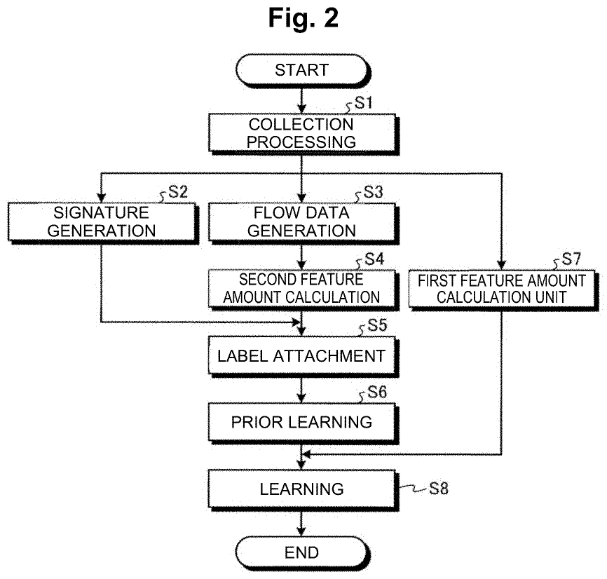

The application discrimination unit 19 discriminates the application corresponding to the IP address of the flow data that is the discrimination target with use of the learned discriminator 18. At the time of discrimination, the application discrimination unit 19 inputs the information on feature amount for discrimination to the learned discriminator 18, and discriminates the application corresponding to the IP address of the flow data that is the discrimination target on the basis of the discrimination result output from the learned discriminator 18. The output unit 20 outputs the discrimination result obtained by the application discrimination unit 19 to an external device, for example.

[Learning Processing] Next, learning processing for the discriminator executed by the discrimination device 10 illustrated in FIG. 1 is described. FIG. 2 is a flowchart illustrating a processing procedure of the learning processing according to the embodiment.

As illustrated in FIG. 2, the collection unit 11 performs collection processing for collecting the packet data D1 of the small-scale NW and the flow data D2 (first flow data) of the discrimination target NW (Step S1).

The signature generation unit 12 analyzes the packet data D1 of the small-scale NW and generates a signature that associates the application and the IP address with each other (Step S2). The flow data generation unit 13 generates the second flow data from the packet data D1 of the small-scale NW (Step S3).

The feature amount calculation unit 15 calculates the second feature amount information that is a statistical feature amount for each IP address for the second flow data (Step S4). At the time of learning, the label attachment unit 16 attaches a label to the second feature amount information with use of the signature generated by the signature generation unit 12 (Step S5). The discriminator learning unit 17 performs prior learning of the discriminator with use of the second feature amount information to which the label generated by the label attachment unit 16 is attached (Step S6).

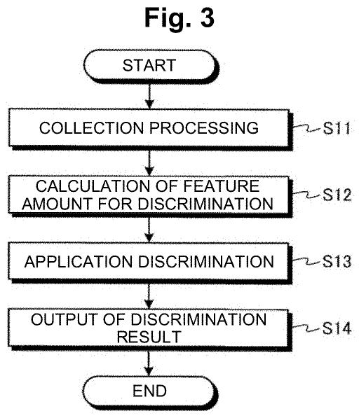

The feature amount calculation unit 15 calculates the first feature amount information that is a statistical feature amount for each IP address for the first flow data (Step S7). The discriminator learning unit 17 performs the learning of the discriminator by domain adaptation with use of the discriminator obtained in the prior learning, the first feature amount information, and the second feature amount information without a label (Step S8). Then, the discriminator learning unit 17 generates the learned discriminator 18.

[Discrimination Processing] Next, discrimination processing for discriminating the application corresponding to the IP address of the flow data of the discrimination target NW executed by the discrimination device 10 illustrated in FIG. 1 is described. FIG. 3 is a flowchart illustrating a processing procedure of the discrimination processing according to the embodiment.

As illustrated in FIG. 3, at the time of discrimination, the collection unit 11 collects the flow data of the discrimination target NW that is a large-scale NW serving as the discrimination target (Step S11). Next, the feature amount calculation unit 15 calculates the information on feature amount for discrimination that is a statistical feature amount for each IP address for the flow data of for the discrimination target NW (Step S12).

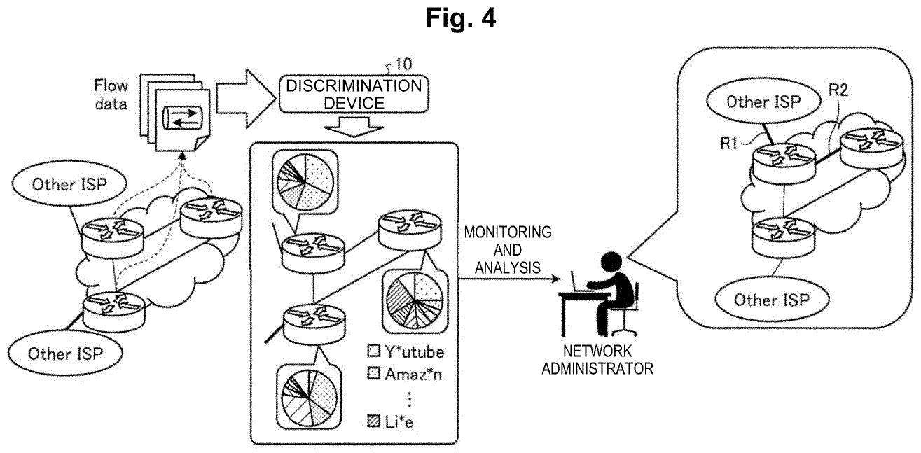

The application discrimination unit 19 discriminates the application corresponding to the IP address of the flow data that is the discrimination target with use of the learned discriminator 18 (Step S13). The output unit 20 outputs the discrimination result obtained by the application discrimination unit 19 to an external device, for example (Step S14).

[Utilization Example 1] A utilization example of the discrimination device 10 is described. FIG. 4 is a diagram describing the utilization example of the discrimination device 10 according to the embodiment.

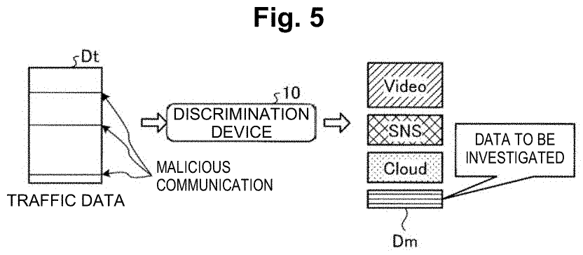

As illustrated in FIG. 4, network flow data collected in an ISP NW is discriminated by the discrimination device 10, and the probability of the IP address of the flow data of the ISP NW providing each application is visualized as the discrimination result. As a result, a network administrator can grasp a detailed NW situation, and can grasp a route (for example, routes R1 and R2) to be intensively invested. As above, by utilizing the discrimination device 10, the efficiency of NW monitoring and the efficiency of a capital expenditure program can be improved by traffic visualization of the ISP network.

[Utilization Example 2] FIG. 5 is a diagram describing another utilization example of the discrimination device 10 according to the embodiment. As illustrated in FIG. 5, the discrimination device 10 is utilized when malicious communication that is contained by a very small amount is detected from large-scale traffic data Dt.

Specifically, the amount of traffic data Dm to be investigated can be reduced by performing the discrimination processing in the discrimination device 10 on the large-scale traffic data Dt and excluding normal traffic from the large-scale traffic data Dt in advance. As above, by applying the discrimination device 10, screening for malicious communication detection can be performed, and the load for the malicious communication detection can be reduced.

[Effects of Embodiment] As above, the discrimination device 10 according to the present embodiment causes the discriminator to learn the flow data of the discrimination target NW that is a large-scale NW without a label and the data of the small-scale NW without a label with use of a domain applying technology after causing the discriminator to perform learning with use of learning data with a label generated from the data of the small-scale NW.

As a result, by using flow data of the discrimination target NW without a label in the learning with use of domain adaptation, the discrimination device 10 can construct the discriminator capable of discriminating the data of the discrimination target NW more accurately as compared to a case where only learning with the learning data with a label generated from the data of the small-scale NW is performed.

As described above, according to the discrimination device 10, the discrimination of the application that has caused traffic becomes possible not only for the data of the small-scale NW but also for the flow data of the large-scale NW in which label attachment has hitherto been difficult, and application-level traffic discrimination becomes also possible in the large-scale NW.

[System Configuration and the like] Each component of each device that is illustrated is a functional concept and does not necessarily need to be physically configured as illustrated. In other words, specific forms of distribution and integration of each device are not limited to those illustrated, and all or a part thereof can be configured by being functionally or physically distributed or integrated in an arbitrary unit in accordance with various loads, usage situations, and the like. All or a part of each processing function performed in each device may be realized by a CPU and a program that is analyzed and executed in the CPU or may be realized as hardware by wired logic.

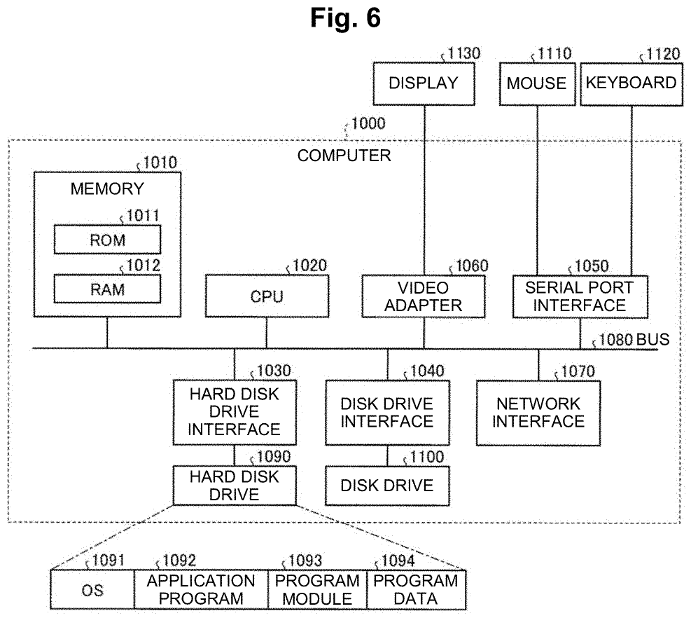

Out of each processing described in the present embodiment, all or a part of the processing described to be automatically performed can also be manually performed, or all or a part of the processing described to be manually performed can also be automatically performed by a well-known method. Other than the above, processing procedures, control procedures, specific names, and information including various data and parameters described and illustrated in the description and the drawings above can be freely changed unless otherwise specified.

[Program] FIG. 6 is a diagram illustrating one example of a computer in which the discrimination device 10 is realized by executing a program. A computer 1000 includes a memory 1010 and a CPU 1020, for example. The computer 1000 includes a hard disk drive interface 1030, a disk drive interface 1040, a serial port interface 1050, a video adapter 1060, and a network interface 1070. Each of those units is connected by a bus 1080.

The memory 1010 includes a read only memory (ROM) 1011 and a RAM 1012. The ROM 1011 stores therein a boot program such as a basic input output system (BIOS), for example. The hard disk drive interface 1030 is connected to a hard disk drive 1090. The disk drive interface 1040 is connected to a disk drive 1100. For example, a mountable and removable storage medium such as a magnetic disk and an optical disk is inserted into the disk drive 1100. The serial port interface 1050 is connected to a mouse 1110 and a keyboard 1120, for example. The video adapter 1060 is connected to a display 1130, for example.

The hard disk drive 1090 stores therein an operating system (OS) 1091, an application program 1092, a program module 1093, and a program data 1094, for example. In other words, the program defining each processing of the discrimination device 10 is implemented as the program module 1093 in which a code executable by a computer is written. The program module 1093 is stored in the hard disk drive 1090, for example. For example, the program module 1093 for executing processing similar to that of the function configuration in the discrimination device 10 is stored in the hard disk drive 1090. The hard disk drive 1090 may be replaced by a solid state drive (SSD).

Setting data used in the processing of the abovementioned embodiment is stored in the memory 1010 and the hard disk drive 1090, for example, as the program data 1094. The CPU 1020 reads out and the program module 1093 and the program data 1094 stored in the memory 1010 and the hard disk drive 1090 to the RAM 1012 and executes the program module 1093 and the program data 1094 as needed.

The program module 1093 and the program data 1094 are not limited to being stored in the hard disk drive 1090 and may be stored in a mountable and removable storage medium and read out by the CPU 1020 via the disk drive 1100 and the like, for example. Alternatively, the program module 1093 and the program data 1094 may be stored in another computer that is connected over a network (a LAN, wide area network (WAN), and the like). The program module 1093 and the program data 1094 may be read out from the other computer by the CPU 1020 via the network interface 1070.

The embodiment to which the invention made by an inventor of the present invention has been described above, but the present invention is not limited by the description and the drawings forming a part of the disclosure of the present invention by the present embodiment. In other words, other embodiments, examples, operation technologies, and the like made by a person skilled in the art and the like on the basis of the present embodiment are all included in the scope of the present invention.

### REFERENCE SIGNS LIST

2A, 2B Small-scale network (NW) equipment
3A, 3B Discrimination target NW router
10 Discrimination device
11 Collection unit
12 Signature generation unit
13 Flow data generation unit
14 Signature database (DB)
15 Feature amount calculation unit
16 Label attachment unit
17 Discriminator learning unit
18 Learned discriminator
19 Application discrimination unit
20 Output unit

1. A discrimination method to be executed by a discrimination device that discriminates an application, the discrimination method comprising:
collecting packet data and first flow data that satisfy a predetermined rule;
analyzing the packet data and generating a signature that associates the application and an IP address with each other;
generating second flow data from the packet data;
calculating first feature amount information that is a statistical feature amount for each IP address for the first flow data, and calculating second feature amount information that is a statistical feature amount for each IP address for the second flow data;
attaching a label to the second feature amount information with use of the signature; and
causing a discriminator to learn discrimination of the application by using the first feature amount information and the second feature amount information as learning data.

2. The discrimination method according to claim 1, further including discriminating an application corresponding to an IP address of flow data that is a discrimination target with use of the discriminator, wherein:
the collecting includes collecting the flow data that is the discrimination target,
the calculating includes calculating information on feature amount for discrimination that is a statistical feature amount for each IP address for the flow data that is the discrimination target, and
discriminating includes inputting the information on feature amount for discrimination to the discriminator and discriminating the application corresponding to the IP address of the flow data that is the discrimination target on basis of a discrimination result output from the discriminator.

3. The discrimination method according to claim 1, wherein the calculating includes calculating at least one of a histogram of a packet count, a histogram of a byte count, or a histogram of the byte count and the packet count from a set of flow data of which transmission source and/or transmission destination is a certain IP address per 24 hours.

4. The discrimination method according to claim 1, wherein the causing includes causing the discriminator to learn the second feature amount information to which the label is attached as learning data in advance, and performing learning of the discriminator by a domain applying technology with use of the first feature amount information and the second feature amount information without a label.

5. A discrimination device that discriminates an application, the discrimination device comprising:
processing circuitry configured to:
collect packet data and first flow data that satisfy a predetermined rule;
analyze the packet data and generate a signature that associates the application and an IP address with each other;
generate second flow data from the packet data;
calculate first feature amount information that is a statistical feature amount for each IP address for the first flow data, and calculate second feature amount information that is a statistical feature amount for each IP address for the second flow data;
attach a label to the second feature amount information with use of the signature; and
cause a discriminator to learn discrimination of the application by using the first feature amount information and the second feature amount information as learning data.

6. A non-transitory computer-readable recording medium storing therein a discrimination program that causes a computer to execute a process comprising:
collecting packet data and first flow data that satisfy a predetermined rule;
analyzing the packet data and generating a signature that associates an application and an IP address with each other;
generating second flow data from the packet data;
calculating first feature amount information that is a statistical feature amount for each IP address for the first flow data, and calculating second feature amount information that is a statistical feature amount for each IP address for the second flow data;
attaching a label to the second feature amount information with use of the signature; and
causing a discriminator to learn discrimination of the application by using the first feature amount information and the second feature amount information as learning data.
